(19) United States
(12) Patent Application Publication
(10) Pub. No.: US 2015/0017294 A1
(43) Pub. Date: Jan. 15, 2015

(54) Crisp Meat Based Food Snacks

(71) Applicant: Home Market Foods, Inc., Norwood, MA (US)

(72) Inventor: Vahid Shahram, Norwood, MA (US)

(21) Appl. No.: 14/323,863

(22) Filed: Jul. 3, 2014

Related U.S. Application Data
(60) Provisional application No. 61/842,624, filed on Jul. 3, 2013.

(51) Int. Cl. A23L 1/317; H05B 6/64; A23L 1/025

(52) U.S. Cl. CPC A23L 1/3177; A23L 1/0255; H05B 6/6408
USPC 426/242; 426/473; 426/641; 426/541; 426/332; 426/392; 219/762

(57) ABSTRACT

Methods and systems of making a meat-based food product, the methods and systems including forming minced meat into a blended form. Methods may include forming minced meat into a blended form. Encasing the blended form, heating the blended form to at least approximately 145° F. to 160° F. Chilling the blended form to at least approximately 40° F. Slicing the chilled blended form into a plurality of slices that have first and second sides spaced apart by a thickness having a range from approximately 0.039 inches to approximately 0.187 inches. Finally, drying the slices in a drying stage by an approximate 1,500 W for approximately 90 seconds to approximately 105 seconds in a dryer to produce dried slices, and moving the dried slices from the dryer stage to a cooling stage, the cooling stage incorporates an ambient air medium passing through the dried slices.

### RELATED APPLICATIONS

This application claims the benefit of and priority to U.S. Provisional Application No. 61/842,624, filed on Jul. 3, 2013, and which is incorporated herein by reference in its entirety.

### BACKGROUND

1. Field

The disclosure relates generally to food processing. More particularly, this disclosure relates to processing meat to produce a fully cooked and dehydrated meat-based snack chip.

2. Background

Snack foods such as potato chips or nacho chips allow a consumer to have a convenient, easily transported food with a crisp texture and appealing flavor. Meat-based snacks have also been popular in consumer culture for their protein and nutritive contributions, such as jerky. However, jerky is very dry, often spicy and tough to eat which is tributed to having a low moisture content. Although, jerky provides a healthier snack for someone, it often fails to measure up to the experience potato chips can provide due to the desirable crispy characteristics. Snack chips generally have high calories, fat, and cholesterol contents because of their manufacturing process which makes them undesirable as a snack food. Also, snack foods being high in fat content causes the food chips to have a shortened shelf life. Some microwave processes have involved treatment of snack foods containing meat, such as beef or pork, but these processes generally contain small bits of the meat mixed with other food products.

It would be advantageous to be able to process meat-based chips which do not have the disadvantageous high calories, high fat, and high cholesterol content as that of potato chips and the like. It would be further advantageous if these meat-based chips would serve as a snack food, and could be prepared in small, snack food packages with a long shelf life.

Therefore, there is a need for meat-based snacks for their protein and nutritive contributions, and by combining chips with meat snacks the outcome can be a meat-based chip.

### SUMMARY

According to some aspects of the present disclosure, there is provided a method of making a meat-based food product that includes forming minced meat into a blended form. Encasing the blended form, heating the blended form to at least approximately 145° F. to 160° F. Chilling the blended form to at least approximately 40° F. Slicing the chilled blended form into a plurality of slices that have first and second sides spaced apart by a thickness having a range from approximately 0.039 inches to approximately 0.187 inches. Finally, drying the slices in a drying stage by an approximate 1,500 W for approximately 90 seconds to approximately 105 seconds in a dryer to produce dried slices, and moving the dried slices from the dryer stage to a cooling stage, the cooling stage incorporates an ambient air medium passing through the dried slices.

According to some aspects of the present disclosure, there is provided a method of making a meat-based food product that includes arranging a plurality of meat slices on a conveyor having a ridged belt with a crevice located between two ridges; drying the slices in a drying stage by a microwave energy device; and depositing the dried slices in a package under a modified atmosphere, wherein oxygen is first removed from the package and the package is filled with one of nitrogen, carbon dioxide or nitrogen blended with carbon dioxide before the slices are deposited into the package.

According to some aspects of the present disclosure, there is provided a system of making a meat-based food product that includes a microwave energy device; and a conveyor having a ridged belt with a crevice located between two ridges, the ridges are configured to support a meat based product, wherein the conveyor belt is positioned relative to the microwave energy device to transport the meat based product through a microwave energy field generated by the microwave energy device.

Further features and advantages will become more readily apparent from the following detailed description when taken in conjunction with the accompanying drawings.

### BRIEF DESCRIPTION OF THE DRAWINGS

The present disclosure is further described in the detailed description which follows, in reference to the noted plurality of drawings by way of non-limiting examples of exemplary embodiments, in which like reference numerals represent similar parts throughout the several views of the drawings, and wherein:

FIG. 1 illustrates an embodiment of a meat chip, according to some embodiments;

FIG. 2A illustrates nutritional charts by weight (28 g) of raw peperoni not of the present disclosure compared with peperoni-chips of the same weight (28 g) of the present disclosure;

FIG. 2B illustrates nutritional charts by weight (28 g) of a type of prior art potato chips not of the present disclosure (Lay's Kettle Cooked Chips by Frito-Lay, Inc.) compared with peperoni-chips of the same weight (28 g) of the present disclosure;

FIG. 2C illustrates nutritional charts by weight (28 g) of a type of prior art potato chips not of the present disclosure (Lay's Potato Cooked Chips by Frito-Lay, Inc.) compared with peperoni-chips of the same weight (28 g) of the present disclosure;

FIG. 2D illustrates nutritional charts by weight (28 g) of a type of prior art related meat product not of the present disclosure (Jack Links Beef Jerky by Link Snacks, Inc.) compared with peperoni-chips of the same weight (28 g) of the present disclosure;

FIG. 2E illustrates nutritional charts by weight (28 g) of a type of prior art related meat product not of the present disclosure (Oberto Beef Jerky by Oberto Sausage Company) compared with peperoni-chips of the same weight (28 g) of the present disclosure;

FIG. 2F illustrates nutritional charts by weight (28 g) of a type of prior art related meat product not of the present disclosure (Oberto Original Beef Jerky Stick by Oberto Sausage Company) compared with peperoni-chips of the same weight (28 g) of the present disclosure;

FIG. 3A is a flowchart of a process of the present disclosure for preparing raw materials to be prepared for meat-based chips, according to some embodiments;

FIG. 3B is a flowchart of a process of the present disclosure using prepared raw materials for preparing meat-based chips, according to some embodiments;

FIG. 4 illustrates using prepared raw materials for preparing meat-based chips, according to some embodiments;

FIG. 5 illustrates a top view of the conveyor belt, according to some embodiments;

FIG. 6A-6C illustrate the conveyor belt, according to some embodiments; and

FIG. 7 illustrates a conditioning process and a packaging process, according to some embodiments.

While the above-identified drawings set forth presently disclosed embodiments, other embodiments are also contemplated, as noted in the discussion. This disclosure presents illustrative embodiments by way of representation and not limitation. Numerous other modifications and embodiments can be devised by those skilled in the art which fall within the scope and spirit of the principles of the presently disclosed embodiments.

### DETAILED DESCRIPTION

The following description provides exemplary embodiments only, and is not intended to limit the scope, applicability, or configuration of the disclosure. Rather, the following description of the exemplary embodiments will provide those skilled in the art with an enabling description for implementing one or more exemplary embodiments. It being understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, systems, processes, and other elements in the invention may be shown as components in block diagram form in order not to obscure the embodiments in unnecessary detail. In other instances, well-known processes, structures, and techniques may be shown without unnecessary detail in order to avoid obscuring the embodiments. Further, like reference numbers and designations in the various drawings indicated like elements.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed, but could have additional steps not discussed or included in a figure. Furthermore, not all operations in any particularly described process may occur in all embodiments. A process may correspond to a method, a function, a procedure, a subroutine, a subprogram, etc. When a process corresponds to a function, its termination corresponds to a return of the function to the calling function or the main function.

I. Overview

It is contemplated the meat-based chip is a fully cooked meat-based snack chip that will have extended shelf life through chemical and atmosphere modification. The product can originate from minced meat products, including specifically pepperoni, but also including other encased meats. For example, beef, pork, lamb, chicken, turkey, fish, shellfish, or to a combination of eatable meat from different animals.

In some embodiments, the dried minced meat can be cured and uncured pepperoni. In some embodiments, the dried minced meats are cured and uncured salami. In some embodiments, the dried minced meats are sliced dry sausages. In some embodiments, the dried minced meat is sliced kielbasa made with beef, pork, and poultry. In some embodiments, the dried minced meats are smoked sausages such as linguica and chorizo made with beef, pork, and poultry.

It is also contemplated in some embodiments the raw materials are encased in order to maintain the uniform round shape of the final product. Further, the minced meat can then be stuffed into a natural or artificial type casing. The mincing of the meat can allow the product to be uniformly distributed leading to consistent dehydration. At least one aspect of the method is to remove the majority of moisture to obtain a product that is less than 4% moisture by weight, which can be accomplished by an industrial microwave and a specially designed conveyor ridged belt. The conveyor ridged belt can be designed to remove excess fat and the microwave energy can remove the moisture. The result of incorporating such an embodiment is that the resulting product will be easy to consume, have appealing texture and flavor and will be consumed alone or with other types of foods as a snack. After cooking and before spices are added via a mixture applicator, natural and artificial antioxidants such as but not limited to ascorbic acid and rosemary extract can be added. It is possible no spice will be added. Further, the product may be packaged in a gas flushed bag with modified atmosphere gases such as but not limited to nitrogen, carbon dioxide, a blend of nitrogen and carbon dioxide and other inert gases.

According to some embodiments, the method includes a method of making a meat-based food product, the method including forming minced meat into a blended form. Encasing the blended form, heating the blended form to at least approximately 145° F. to 160° F. Chilling the blended form to at least approximately 40° F. Slicing the chilled blended form into a plurality of slices that have first and second sides spaced apart by a thickness having a range from approximately 0.039 inches to approximately 0.187 inches. Finally, drying the slices in a drying stage by an approximate 1,500 W for approximately 90 seconds to approximately 105 seconds in a dryer to produce dried slices, and moving the dried slices from the dryer stage to a cooling stage, the cooling stage incorporates an ambient air medium passing through the dried slices.

II. Meat Processing Method and System

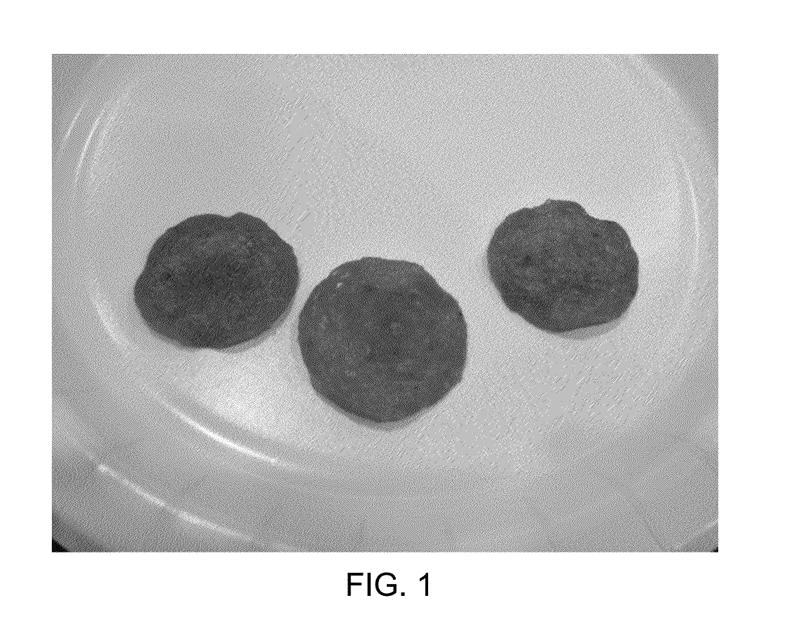

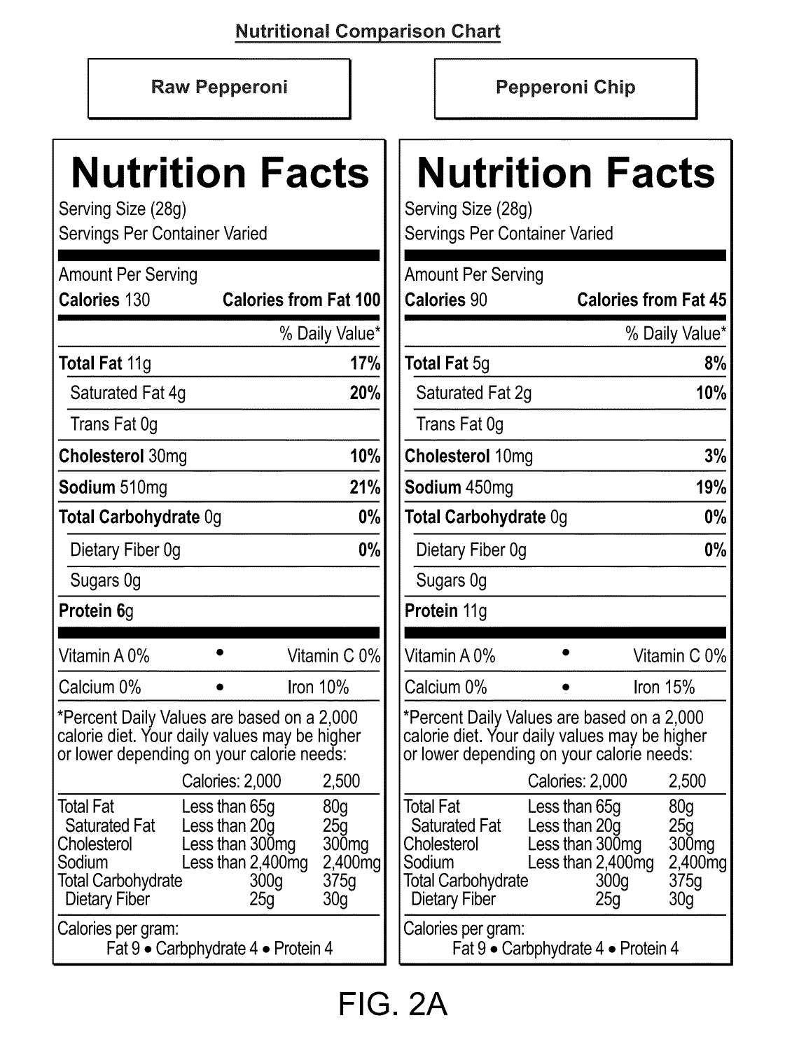

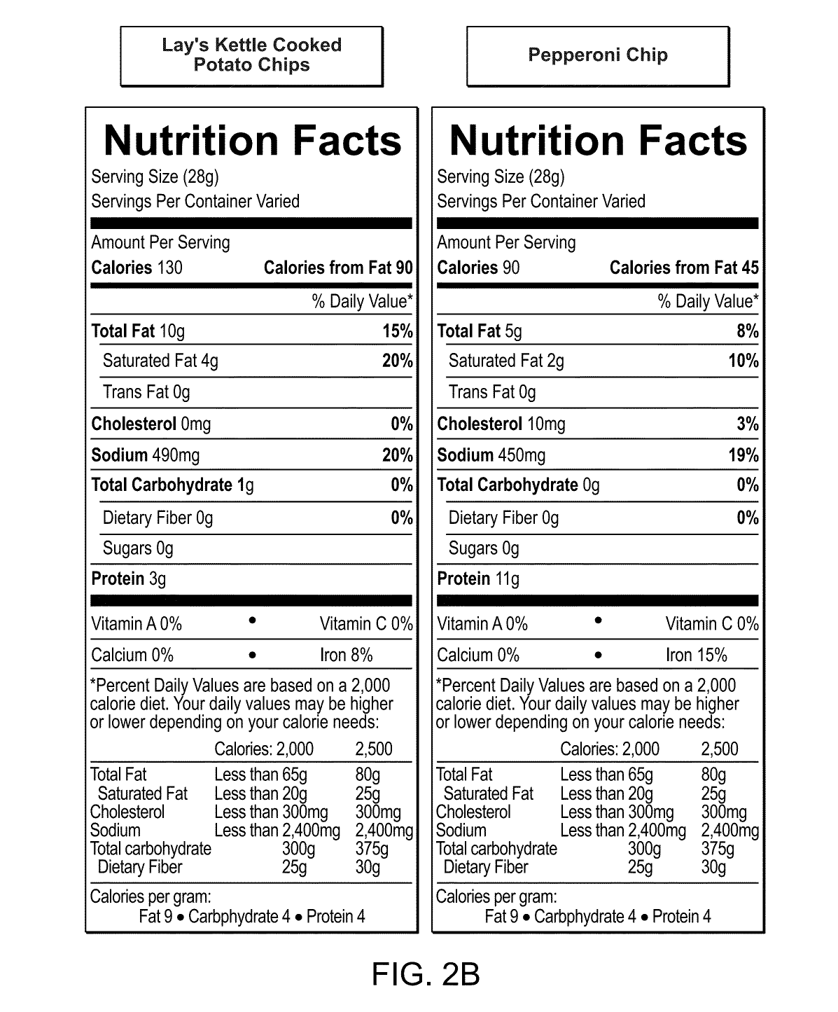

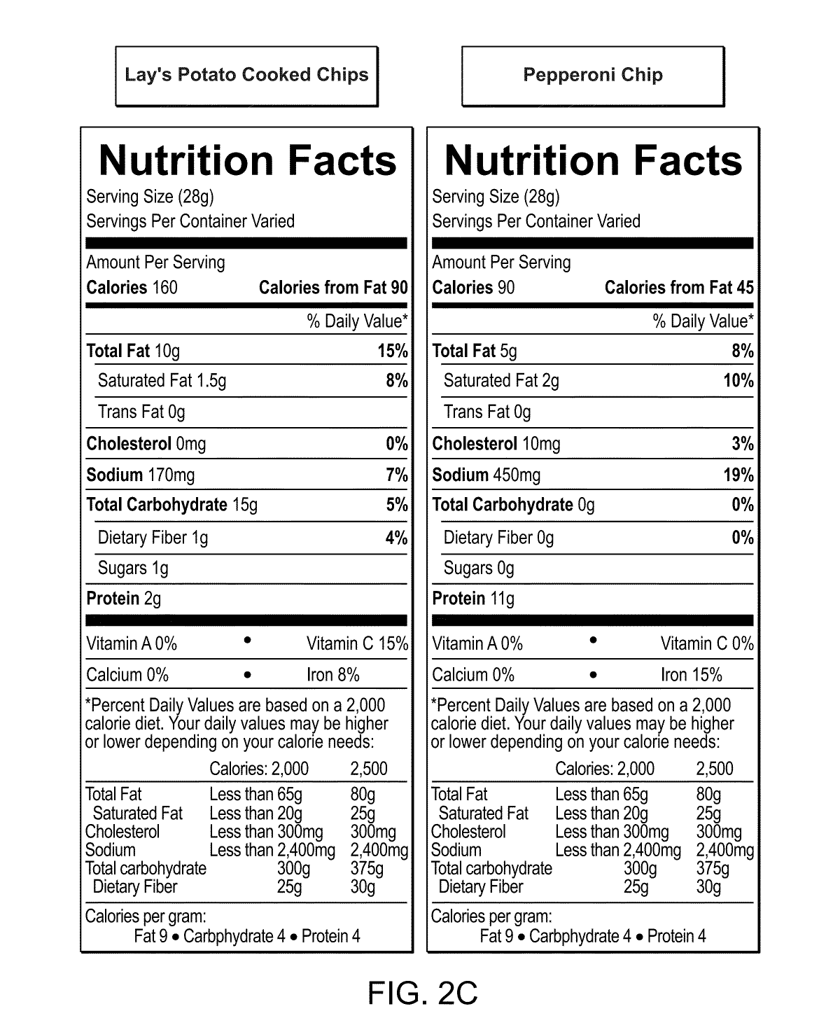

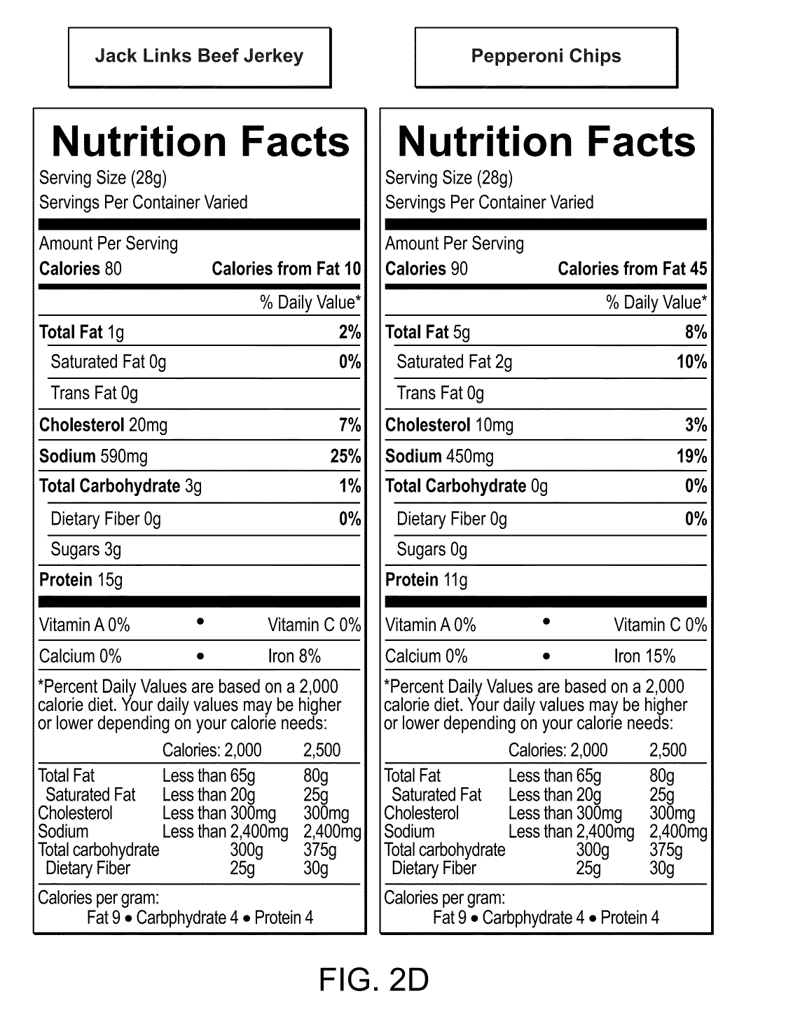

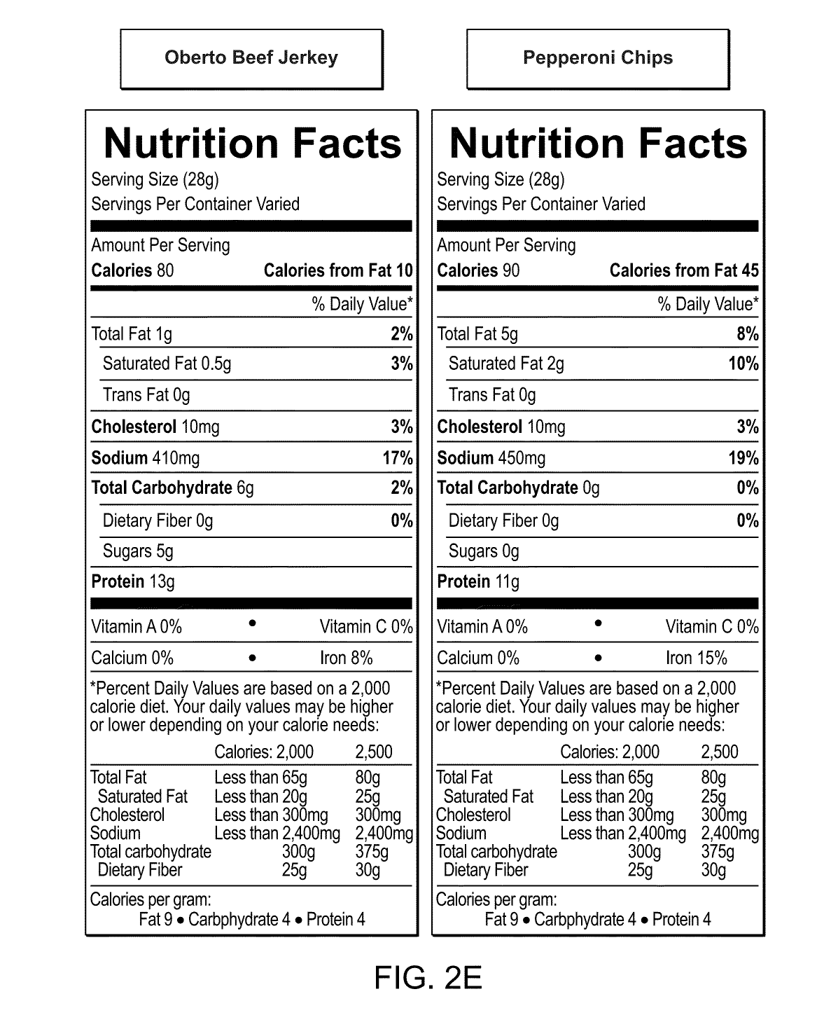

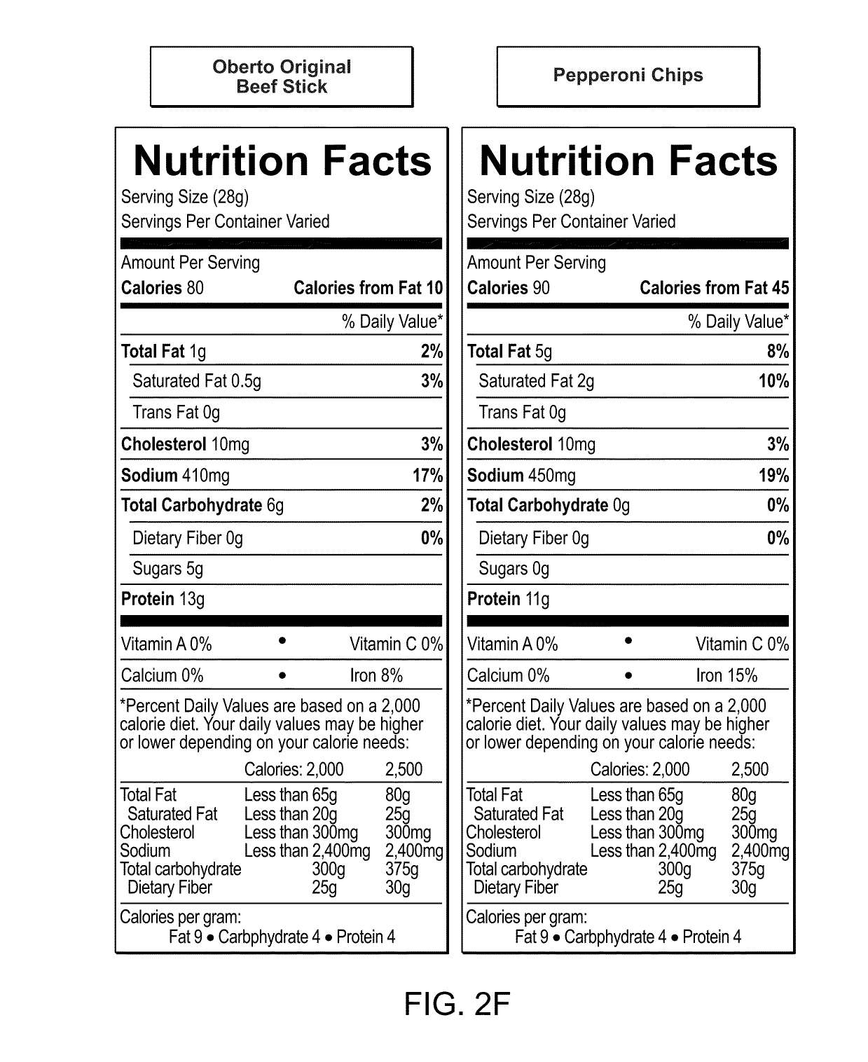

As noted above, aspects of the disclosure provide methods and systems for making meat-based products. FIG. 1 illustrates an embodiment of a meat-based chip 100 of the present disclosure. As shown in FIG. 1, the meat-based chip 100 provides the desirable crispy characteristics, which will remain stable at ambient temperatures. In some embodiments, a dried meat-based chip is provided with less than 4% moisture, after dehydration through an industrial process microwave. The Microwave energy is used to remove the moisture from the chip which is approximately 1,500 Watts, wherein the exposure time for each chip is estimated at approximately 90-105 seconds. Further, each chip is placed on an in line conveyer belt, and transported to the microwave stage located along the conveyor belt. As a result of the meat-based chip (or product) being exposed to the Microwave energy it will result in having a high protein content, but a lower fat content than products such as sausages and pepperoni snack sticks. Because this is a meat-based product, it has more protein when compared with starch and carbohydrate based chips, or meat snacks with added sugars (see FIGS. 2A-F). The microwaving process of the present disclosure eliminates some of the fat but retains the protein. The target fat removal percentage from the meat-based chip is between 18-20% by weight.

As noted above FIGS. 2A to 2F illustrate nutritional charts for the products of the present disclosure as well as competing products. For example, FIG. 2A illustrates nutritional charts by weight (28 g) of a raw pepperoni that is compared to products of the present disclosure. FIG. 2B illustrates nutritional charts by weight (28 g) of a type of potato chip (Lay's Kettle Cooked Chips by Frito-Lay, Inc.) which is compared with the peperoni-chips of the same weight (28 g) of the present disclosure. FIG. 2C illustrates nutritional charts by weight (28 g) of a type of potato chips (Lay's Potato Cooked Chips by Frito-Lay, Inc.) that is compared with the peperoni-chips of the same weight (28 g) of the present disclosure. FIG. 2D illustrates nutritional charts by weight (28 g) of a type of related meat product (Jack Links Beef Jerky by Link Snacks, Inc.) that is compared with peperoni-chips of the same weight (28 g) of the present disclosure. FIG. 2E illustrates nutritional charts by weight (28 g) of a type of related meat product (Oberto Beef Jerky by Oberto Sausage Company) which is compared with peperoni-chips of the same weight (28 g) of the present disclosure. Finally, FIG. 2F illustrates nutritional charts by weight (28 g) of a type of related meat product (Oberto Original Beef Jerky Stick by Oberto Sausage Company) that is compared with peperoni-chips of the same weight (28 g) of the present disclosure. Most recent tests of fat percentage are expressed in FIGS. 2A-F. However, this may vary based on raw materials, which may have a spectrum of fat levels.

The meat-based chip is a fully cooked meat-based snack chip that will have extended shelf life through chemical and atmosphere modification. The product can originate from minced meat products, including specifically pepperoni, but also including other encased meats. For example, as noted above, beef, pork, lamb, chicken, turkey, fish, shellfish, or to a combination of eatable meat from different animals.

The dried minced meat can be cured and uncured pepperoni. The dried minced meats can be cured and uncured salami. The dried minced meats can be sliced dry sausages. Further, the dried minced meat can be sliced kielbasa made with beef, pork, and poultry. Further still, the dried minced meats can be smoked sausages such as linguica and chorizo made with beef, pork, and poultry.

The raw materials are encased in order to maintain the uniform round shape of the final product. The minced meat can then be stuffed into a natural or artificial type casing. The mincing of the meat can allow the product to be uniformly distributed leading to consistent dehydration.

At least one aspect of the method is to remove the majority of moisture to obtain a product that is less than 4% moisture by weight, which can be accomplished by an industrial microwave and a specially designed conveyor ridged belt. The conveyor ridged belt can be designed to remove excess fat and the microwave energy can remove the moisture. The result of incorporating such an embodiment is that the resulting product will be easy to consume, have appealing texture and flavor and will be consumed alone or with other types of foods as a snack.

After cooking and before spices are added via a mixture applicator, natural and artificial antioxidants can be added. For example, it is possible the meat-based chips of the present disclosure can be treated with a natural preservative and/or artificial preservative prior to packaging. For example, the natural preservative can add a unique quality to the product which is unique because it will allow the product to have a sustained shelf life of at least 90 days at room temperature, as noted above. Preservatives may be selected from antioxidants or anti-rancidity preservatives or the like. The microwaving process described above and the subsequent shelf stability requirement requires this type of preservation (anti-rancidity) because due to a higher fat content than dried meats, the meat is releasing oil through the process and that oil will become rancid with the exposure to oxygen. Because this oil may accumulate on the product, it may be desirable to stabilize the product by preservatives capable of preventing rancidity, such as rosemary extract or ascorbic acid. Other suitable preservatives include, but are not limited to BHT (Butylated Hydroxy Toluene), TBHQ (Treitiary Butyl Hydo Quinone), polyphenol antioxidant, Chicoric acid, Chlorogenic acid, Cinnamic acid and its derivatives, such as ferulic acid, Ellagic acid, Ellagitannins, Gallic acid, Gallotannins, Rosmarinic acid, Salicylic acid. All preservatives may be used with recommended dosages based on FDA regulations and the manufacture, such as between about 0.05 to about 2%.

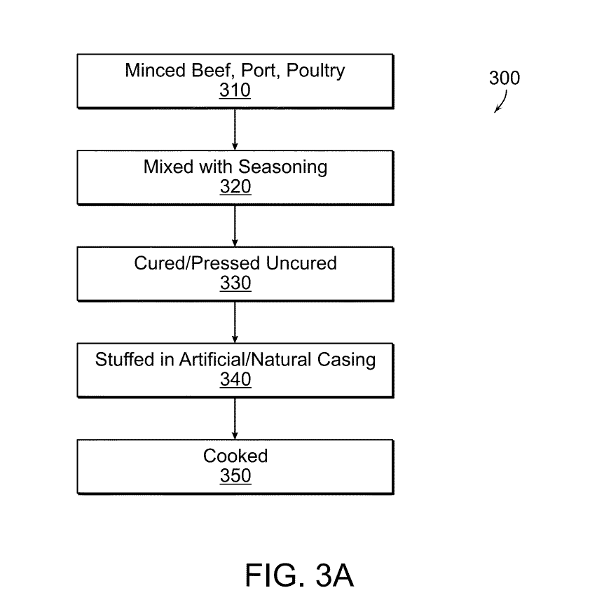

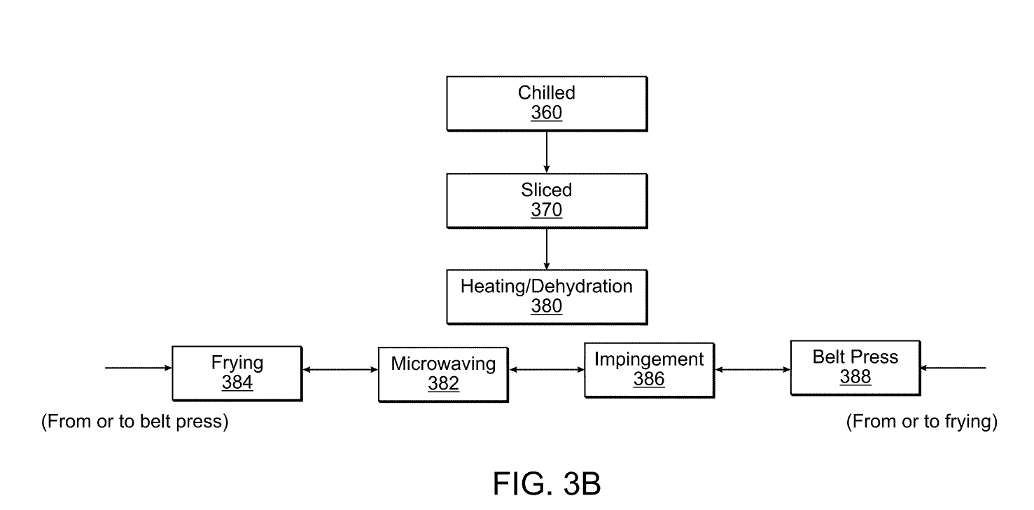

FIGS. 3A and 3B illustrate a flowchart of a meat processing system 300 in accordance with some embodiments. As shown in FIG. 3A, the meat processing system 300 generally includes a mincing system 310 where the raw materials are prepared by first mincing meats (beef, pork, and/or poultry). A mixing station 320 is provided for mixing various seasonings, such as seasonings containing curing salts or celery powder. In addition it is contemplated that rosemary extract and ascorbic acid may be added to the mixture as an antioxidant to prevent fat oxidation/rancidity. Further, a curing/pressed uncured station 330, and an artificial/natural casing station 340 which provides for the minced meat to be then stuffed into a casing, and a cooking station 350.

FIG. 3B illustrates the meat processing system 300 having a chilling station 360, slicing station 370 and a heating/dehydration station 380. The heating/dehydration station 380 utilizes a microwave energy device 382.

Microwaving results in a product with a relatively low moisture percentage (1-4% is an acceptable moisture percentage). Microwaving heats and dehydrates the product to sufficiently release moisture and fat. This process turns the texture of the product from a moist, oily, flexible texture to a dry, stiff, and crispy texture.

The microwaving process described here will result in a crispy product, without the need of a frying or baking of the product to get a crispy product. The processing will go through microwave energy in an industrial scale lieu of a traditional dehydration process. Microwave is the preferred method for this application, because traditional dehydration involves heat and moisture removal through hot air. Compared to other types of dehydration systems, such as tray or cabinet dryers which require high air velocity to move over the top of the exposed product and require that the trays be rotated. This rotation is often uncontrolled and leads to non-uniform drying within the system. With tunnel dryers the product is pushed through a tunnel with air either direction either concurrent or counter-current circulation. The counter-current has a higher efficiency than the concurrent, but often leads to lower quality product. Since air cannot be controlled as much as waves of heat these systems are inconsistent and wasteful. In addition to moisture loss the microwave also acts to remove fat from the final product. The removal of fat helps improve the nutritional value by decreasing the total calorie count and decreasing exposure to saturated fat. The microwave removes this fat by heating the product and causing purge which is collected and disposed of by Environmental Protection Agency (EPA) guidelines.

Microwave is the preferred method for this application, because it creates the right crisp texture, without the interference of excess oil. Among one of the many challenges encountered in the design of the meat-based chip was to create the right crisp texture, without the interference of excess oil, and without the use of cloth to absorb the fat. Crispness from a textural kinetics definition would be a textural or sensual experience from eating a food which fails in a brittle manner with a low load. It would be seen as having either glassy or cellular qualities with defined fracture ability. Crispness is unique as it is not as easily defined as “hardness” or “crunchiness. One of the best ways to identify crispness is through sensory evaluation; through the feel in the mouth and auditory characteristics (Vincent, Julian. “Application of Fracture Mechanics to the Texture of Food.” Anales de mecanica de la fractura. 20. (2003): n. page. http://www.gef.es/congresos/20/pdf/gef098.pdf).

In some embodiments, the process of the present disclosure achieves the desired texture by removing the oil and moisture, while preventing rapid oil degradation. Thus, achieving all three objectives is challenging and these challenges can be resolved by using the modified conveyor belt, as is described in detail below.

Still referring to FIG. 3B, in addition to microwave 382, the meat chips of the present disclosure may be processed by forms of dry heat such as an impingement oven 386. Frying 384 may be used to help improve crispness of products if needed; frying may be done by using frying oil with a low rate of rancidity such as sunflower oil. Finally, the dried minced meat can be further cooked in a belt press oven 388.

As noted above, to increase shelf life of the meat chips of the present disclosure, the meat chips may be packaged in a modified nitrogen gas atmosphere. The modified atmosphere is advantageous as it will be an odorless gas that drastically increases the shelf life of the product. Product will be presented in a modified atmosphere package that will prolong shelf life at ambient room temperature when compared to similar products and will limit or inhibit rancidity. When oxygen is present it will react with fat causing a molecule to form that will have a rancid smell and taste. By replacing oxygen with nitrogen inside the packaging, we will be able to limit these reactions that would typically take place, thus extending the shelf life of the product. In some embodiments, nitrogen and carbon dioxide blend may be used.

In some embodiments, the products of the present disclosure will be a shelf stable product without the addition of silica gels. This improves shelf stability without added waste and possible health risk. As noted above, the shelf life of this product will be at least 90 days at room temperature. The benefit of improved shelf life is to allow product to be stable at ambient room temperatures. The ambient temperature will allow for non-refrigerated transportation and storage. The decreased water content also increases shelf life and will decrease the weight of the product making it easier and more cost-efficient to ship and transport.

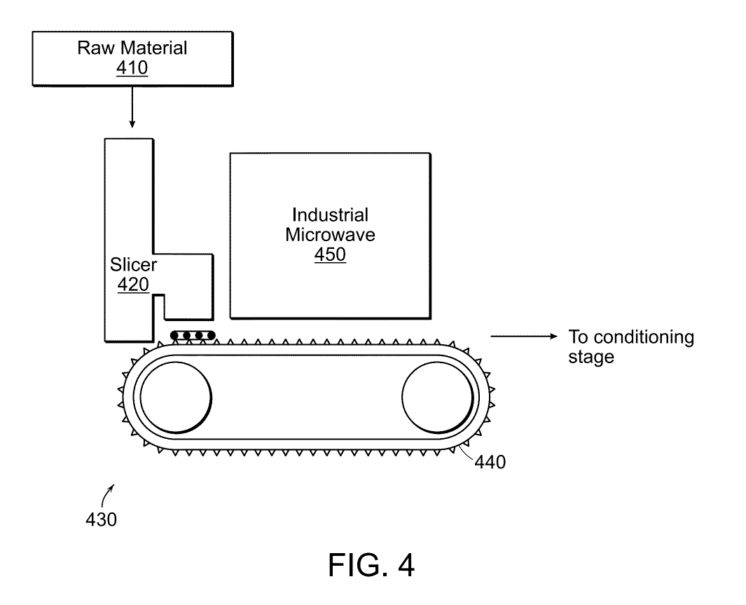

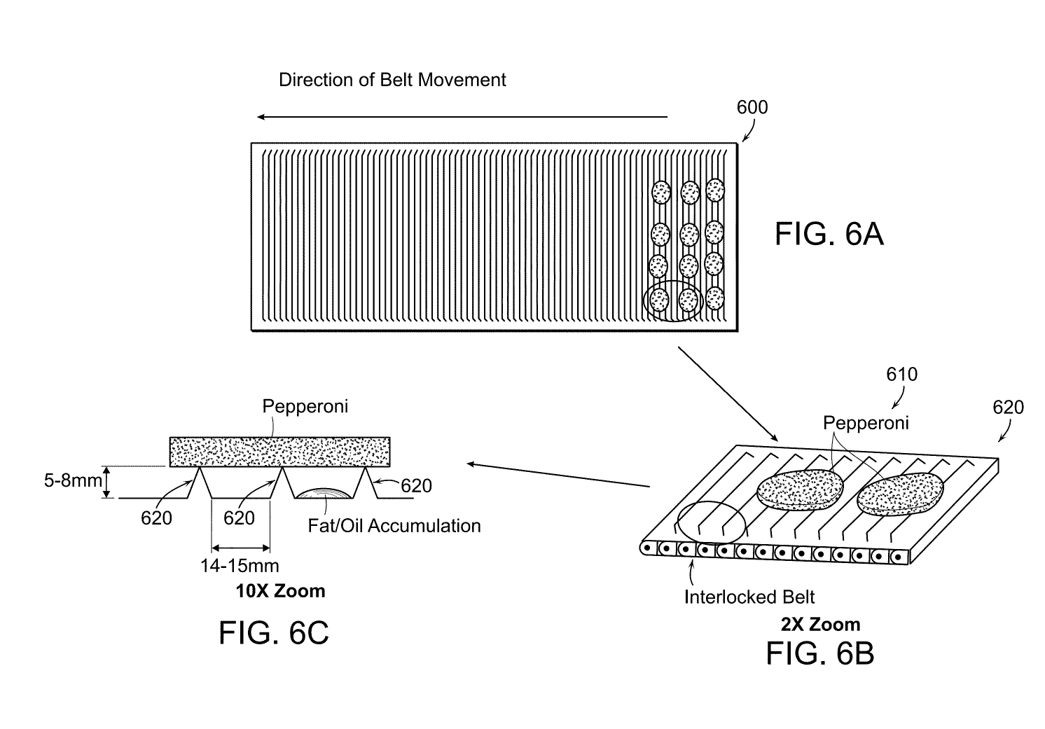

In reference to FIG. 4, the raw materials 410 may be sliced through an automatic slicer 420 onto a modified conveyor belt 440 of a conveyor 430. The slices will be 1/20 to 3/16 inch. The slices will be circular in shape and may have slight curing at the edges. In some embodiments, the diameter will be about 30 to about 45 mm. The thickness will be about 1.0 mm to about 1.5 mm. The weight will range from about 0.03 to about 0.6 oz. The slices are then taken through an industrial microwave on a ridged belt, as shown in FIG. 4. Industrial microwave 450 with a modified belt 440 may be used to remove oil and moisture. For example, the structure of the ridges on the belt can be V-shaped where the height may vary from approximately 5 mm to 8 mm (see FIG. 6C). Further, the distance between two ridges is the crevice which is approximately 14 mm to 30 mm apart (see FIG. 6C).

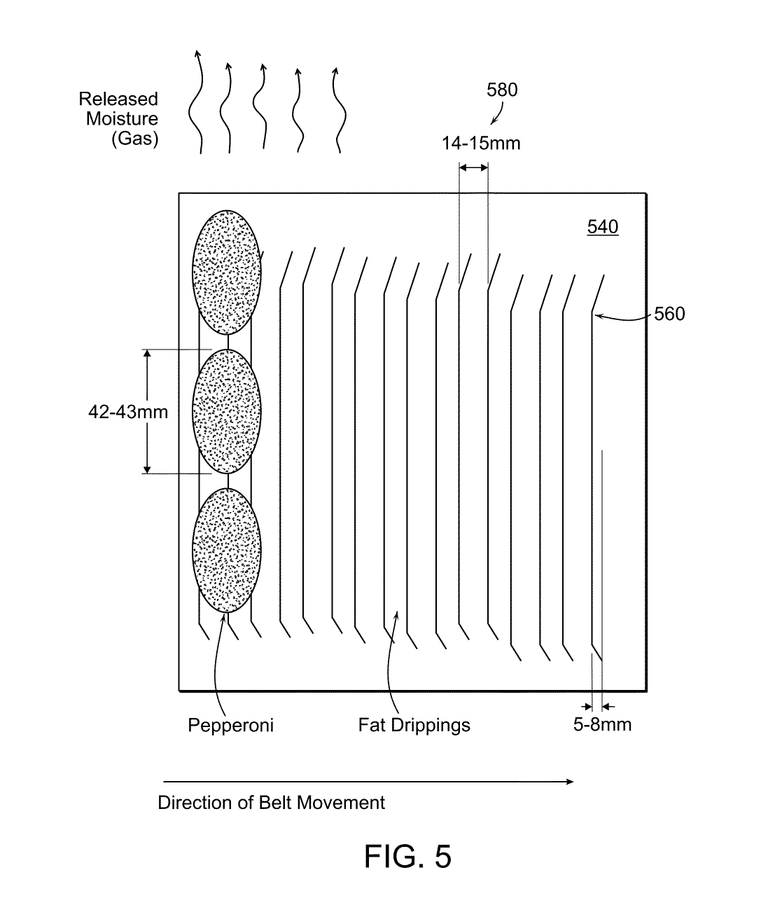

In reference to FIG. 5, the slices will be placed on a specially designed belt 540 with spaced apart ridges 560. The ridges 560 will allow about 18 to about 20% (based on total weight of product) reduction in fat, but will still allow some fat on the product to help carry flavor and produce desired mouth-feel. The ridges 560 will allow fat reduction by holding the slices on the top of the ridge 560, while the fat is released into the crevice 580 of the belt 540. As noted above, the crevice 580 is located between two ridges 560. Accordingly, the microwaving product will result in a product with a reduced fat content as well as a reduced water content. The modified belt design was determined through experimentation. First, the material needed to be microwave safe and have a high tolerance for heat. Ridge height needed to be determined as ridges that are too high would be difficult to clean and could create sanitation concerns. Ridges that are too low would cause the chip to gain access to the fat it had released to cooking and interfere with the cooking process. Taller ridges provided the crispest products but any height above 8 mm would be more costly to produce and have an impact on sanitation.

Referring to FIGS. 6A-C, in some embodiments, the ridges 620 may vary in spacing between about 3 mm and about 20 mm, depending on the size of the slices. In some embodiments, the crevices are spaced approximately 14 mm to about 15 mm apart. In some embodiments, the height of ridges will about 5 to about 8 mm. This size of the crevice is selected based on the need to ensure that the meat slices have sufficient support on all sides as the slices are cooked. If support is lacking part or the entire chip may fall in the crevice and absorb excessive fat that is released while cooking. These ridges 560 are designed to remove excess fat without the use of unsustainable absorbent materials. This produces a dry crisp product without excessive fat. It is contemplated that two to three ridges 620 will support each slice with the ridge being approximately 2.1 mm at the apex of the ridge and with the bottom of the ridge being approximately 3.2 mm. The crevices 580 will be approx. 14-15 mm apart, this is optimal to assure proper support for the pepperoni, but also allow for proper rendering of fat.

Still referring to FIGS. 6A-C, the speed of the conveyor is associated with the size of the slices. As the size of the slices increase (approximately 45 mm compared with 30 mm), the belt 600 will need to increase to assure consistent product dispersion. Also the best speed will also depend on thickness of the slice. As a product gets thicker the belt will need to be slowed. It is possible that the ridges can vary in height from approximately 5 mm to 8 mm, as noted above. Further, as the slices increases in size more support will be needed by more ridges, for example a minimum of two ridges for 30 mm and minimum of three ridges for 45 mm. These ridges are designed for a pepperoni product or a like that is cold and significantly firm after sliced. Pepperoni with increased moisture content and oil may be too soft and cause curling on ridges. For example, the varying ridges are to allow for specific size and shape of the product.

Still referring to FIGS. 6A-C, the belt 600 is a pin-style joint interlocking belt with modified ridges to allow for a product to be dehydrated on the apex of the joint, and oil to fall into the crevice of the joint.

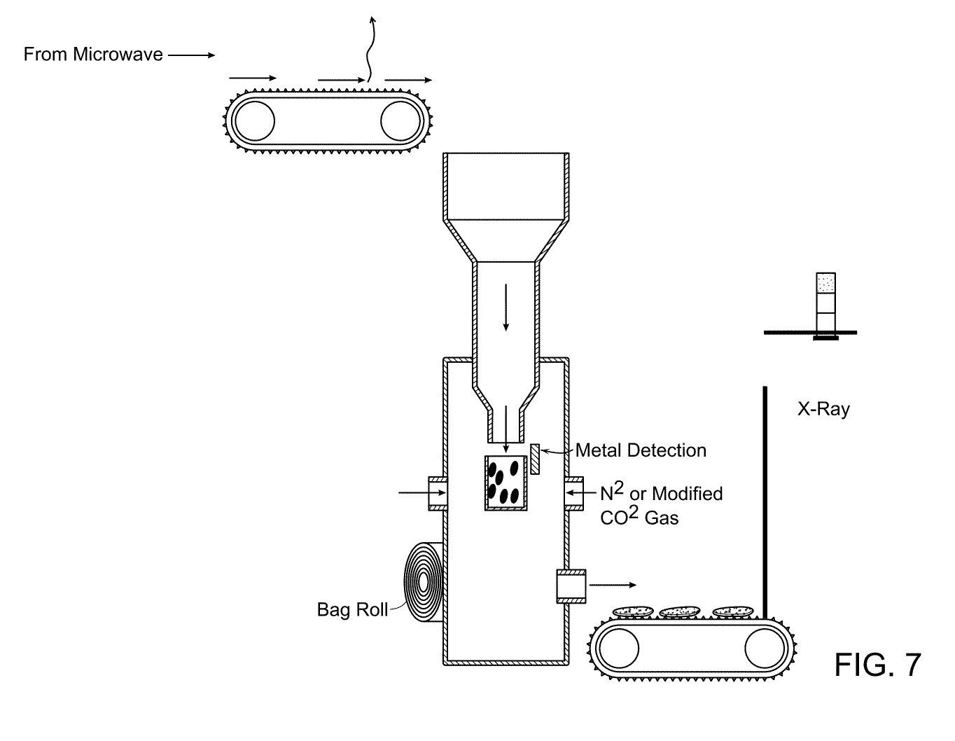

In reference to FIG. 7, upon being released from the microwave the crispy slices are placed on another conveyor where they begin to cool on their way to be packaged. Before completely cooling, the slices are subjected to seasoning, including preservatives (for example, with added ascorbic acid and/or rosemary extract), which is sprayed in an even coating. The slices may also be seasoned, wherein the seasoning may consist of various flavors such as buffalo, ranch, or barbeque or be flavorless.

In packaging, the meat chips are placed into bag and flushed of oxygen. Once the oxygen is removed nitrogen gas is then used to partially fill the bag. The bag is then sealed and subjected to various quality controls and then placed into case boxes. These cases are then stacked and prepared for shipping, as shown in FIG. 7.

According to some of the methods of the present disclosure the meat-based snack produced is rich in protein and lower in fat compared to pepperoni or other similar products currently in the market. Nitrogen modified atmosphere and natural antioxidants may be used in place of silica gels and other oxygen absorbing preservation methods in packaging. With modified atmosphere and addition of antioxidants and/or anti-rancidity agents such as ascorbic acid and rosemary extract this problem has been overcome.

The meat chips of the present disclosure may be mass produced and provide an industrial scale production solution. This mass production of meat chips will provide metal detection, x-ray, and other quality measures. This mass production will consist of a ridged belt previously described which will allow moisture to be released and the majority (but not all) of fat to be removed. This method will not employ an absorbent cloth or traditional microwaves; these other processes allow for only small batches to be produced at a time and result in a shorter shelf life. The end product discussed throughout will be economically advantageous over more conventional methods and will result in a safe food product for all to consume.

The combination of the packaging and natural preservatives described previously allow the meat chips of the present disclosure to be sold in the mass market due to its extended shelf life and extended stability at ambient room temperature. This is unique to the combination of the microwaving process, addition of natural preservatives, and modified atmosphere packaging.

The processes of the present disclosure are economically advantageous because of the amount it allows to be produced at one time which can result in larger sales. The presently disclosed processes will also have less waste than other similar processes. The process will be on a mass scale consisting of a reusable belt that will not only improve efficiency but will decrease waste from oil soaked rags that will lead to an increase in cost from trash disposal. The process itself will be mostly automated and is designed to be produced in a manufacturing facility.

The methods of the present disclosure may eliminate the use absorbent materials, which are costly and inefficient. The process also reduces environmental impact and waste be eliminating the use of cloth to absorb fat or oil.

In some embodiments, the dried minced meat will be fried for 2-6 minutes at 300° F.-325° F. In some embodiments, the dried minced meat is then dried using a dry heat impingement oven. In some embodiments, the dried minced meat is then dried using continuous a belt microwave. In some embodiments, the dried minced meat is then dried using continuous direct heat press oven.

In some embodiments, the dried minced meat has no spices applied. In some embodiments, the dried minced meat after cooking is then passed under a mixture applicator which will contain Antioxidant and anti-rancidity agents. In some embodiments, the dried minced meat is then placed in a bag with a modified atmospheric packaging. In some embodiments, this gas is nitrogen. In some embodiments, this gas is carbon dioxide.

In some embodiments, a method of making a meat-based food product is provided, which may include slicing a blended form into a plurality of slices that have first and second sides spaced apart by a thickness having a range from approximately 0.039 inches to approximately 0.187 inches; drying the slices in a drying stage by a microwave energy device; and moving the dried slices from the dryer stage to a cooling stage, the cooling stage incorporates an ambient air medium passing through the dried slices. In some embodiments, the method further includes the steps of forming meat into the blended form, the meat being a minced meat; encasing the blended form; heating the blended form to at least approximately 145° F. to 160° F.; and chilling the blended form to at least approximately 40° F. In some embodiments, the slices are arranged in a monolayer configuration in the drying stage on a conveyor having a ridged belt with a crevice located between two ridges. Drying of the slices in the drying stage may be furthered by the slices being supported by the ridges, the ridges provide partial removal of the fat from the slices as well as allow a portion of the fat to remain on the slices to allow for flavor and a desired mouth texture experience. In some embodiments, the ridges of the ridged belt vary in a height approximately 5 mm to 8 mm, the crevices are approximately 14 mm to 15 mm apart so that two to three ridges support each slice.

In some embodiments, a system for making a meat-based food product may be configured to perform the following steps: slicing the chilled blended form into a plurality of slices that have first and second sides spaced apart by a thickness having a range from approximately 0.039 inches to approximately 0.187 inches; drying the slices in a drying stage by a microwave energy device; moving the dried slices from the dryer stage to at least one other stage, the at least one other stage includes stages one of a cooling stage, a seasoning agent stage, a preservative agents stage or a packaging stage. In some embodiments, the system may be configured to form meat into the blended form, the meat being a minced meat; encase the blended form; heat the blended form to at least approximately 145° F. to 160° F.; and chill the blended form to at least approximately 40° F. In some embodiments, the slices may be arranged in a monolayer configuration in the first drying stage on a conveyor having a ridged belt with a crevice located between two ridges. In some embodiments, drying of the slices in the drying stage may be furthered by the slices resting on the ridges, the ridges provide partial removal of the fat from the slices as well as allow a portion of the fat to remain on the slices to allow for flavor and a desired mouth texture experience.

In some embodiments, a method of making a meat-based food product includes forming minced meat into a blended form. Encasing the blended form, heating the blended form to at least approximately 145° F. to 160° F. Chilling the blended form to at least approximately 40° F. Slicing the chilled blended form into a plurality of slices that have first and second sides spaced apart by a thickness having a range from approximately 0.039 inches to approximately 0.187 inches. Finally, drying the slices in a drying stage by an approximate 1,500 W for approximately 90 seconds to approximately 105 seconds in a dryer to produce dried slices, and moving the dried slices from the dryer stage to a cooling stage, the cooling stage incorporates an ambient air medium passing through the dried slices.

In some embodiments, a method of making a meat-based food product includes arranging a plurality of meat slices on a conveyor having a ridged belt with a crevice located between two ridges; drying the slices in a drying stage by a microwave energy device; and depositing the dried slices in a package under a modified atmosphere, wherein oxygen is first removed from the package and the package is filled with one of nitrogen, carbon dioxide or nitrogen blended with carbon dioxide before the slices are deposited into the package.

In some embodiments, the method further includes forming minced meat into a blended form; encasing the blended form; heating the blended form to at least approximately 145° F. to 160° F.; chilling the blended form to at least approximately 40° F.; and slicing the chilled blended form into a plurality of meat slices that have first and second sides spaced apart by a thickness having a range from approximately 0.039 inches to approximately 0.187 inches. In some embodiments, the method further comprises moving the dried slices from the dryer stage to a cooling stage, the cooling stage incorporates an ambient air medium passing through the dried slices. The slices may be dried by an approximate 1,500 W for approximately 90 seconds to approximately 105 seconds in a dryer to produce dried slices. The minced meat may be two or more minced meats, a ground meat, two or more ground meats or some combination thereof. In some embodiments, forming of the minced meat may include adding at least one substance, the at least one substance includes one or more seasoning, one or more preservative or some combination thereof. The drying stage may produce slices having a degree of crispness via a textural kinetics definition. The drying stage may produce slices having an approximate four percent moisture content or less. In some embodiments, a target fat removal percentage of the slices is between 18-20% by weight after exiting the drying stage. In some embodiments, at least one second substance is added to the dried slices during a second stage, the at least one second substance includes one or more preservative, one or more antioxidant, one or more anti-rancid substance, one or more seasoning including a flavoring agent or some combination thereof. In some embodiments, the preservative substance is from the group consisting of one of rosemary extract, ascorbic acid, Butylated Hydroxy Toluene (BHT), Treitiary Butyl Hydo Quinone (TBHQ), polyphenol antioxidant, Chicoric acid, Chlorogenic acid, Cinnamic acid and Cinnamic acid derivatives. Upon exiting the drying stage the slices may be packaged in a modified atmosphere, wherein oxygen is first removed from the package and filled with one of nitrogen, carbon dioxide or nitrogen blended with carbon dioxide before the slices are deposited into the package. Drying of the slices in the drying stage may be furthered by the slices resting on the ridges, the ridges provide partial removal of the fat from the slices as well as allow a portion of the fat to remain on the slices to allow for flavor and a desired mouth texture experience. In some embodiments, the ridges of the ridged belt vary in a height approximately 5 mm to 8 mm, a crevice is located between the ridges having a length approximately 14 mm to 30 mm apart so that two to three ridges support each slice. The ridged belt may be a pin-style joint interlocking belt, the ridges allow the slices to be dehydrated on the apex of each ridge for oil from each slice to fall into the crevice.

In some embodiments, a system of making a meat-based food product may include a microwave energy device; and a conveyor having a ridged belt with a crevice located between two ridges, the ridges are configured to support a meat based product, wherein the conveyor belt is positioned relative to the microwave energy device to transport the meat based product through a microwave energy field generated by the microwave energy device.

In some embodiments of such systems, the ridges of the ridged belt may vary in a height approximately 5 mm to 8 mm, a crevice located between two ridges has a length approximately 14 mm to 30 mm apart so that two to three ridges support each slice. In some embodiments, the ridged belt is a pin-style joint interlocking belt, the ridges allow the slices to be dehydrated on the apex of each ridge for oil from each slice to fall into the crevice.

Whereas many alterations and modifications of the present disclosure will no doubt become apparent to a person of ordinary skill in the art after having read the foregoing description, it is to be understood that the particular embodiments shown and described by way of illustration are in no way intended to be considered limiting. Further, the disclosure has been described with reference to particular preferred embodiments, but variations within the spirit and scope of the disclosure will occur to those skilled in the art. It is noted that the foregoing examples have been provided merely for the purpose of explanation and are in no way to be construed as limiting of the present disclosure. While the present disclosure has been described with reference to exemplary embodiments, it is understood that the words, which have been used herein, are words of description and illustration, rather than words of limitation. Changes may be made, within the purview of the appended claims, as presently stated and as amended, without departing from the scope and spirit of the present disclosure in its aspects. Although the present disclosure has been described herein with reference to particular means, materials and embodiments, the present disclosure is not intended to be limited to the particulars disclosed herein; rather, the present disclosure extends to all functionally equivalent structures, methods and uses, such as are within the scope of the appended claims.

What is claimed is:

1. A method of making a meat-based food product comprising:
slicing a blended form of meat into a plurality of slices that have first and second sides spaced apart by a thickness having a range from approximately 0.039 inches to approximately 0.187 inches;
drying the slices in a drying stage by an approximate 1,500 W for approximately 90 seconds to approximately 105 seconds in a dryer to produce dried slices; and
moving the dried slices from the dryer stage to a cooling stage, the cooling stage incorporates an ambient air medium passing through the dried slices.

2. The method of claim 1, further comprising:
forming meat into the blended form, the meat being a minced meat;
encasing the blended form;
heating the blended form to at least approximately 145° F. to 160° F.; and
chilling the blended form to at least approximately 40° F.

3. The method of claim 2, wherein the minced meat is two or more minced meats, a ground meat, two or more ground meats or some combination thereof.

4. The method of claim 1, wherein forming of the meat includes adding at least one substance, the at least one substance includes one or more seasoning, one or more preservative or some combination thereof.

5. The method of claim 1, wherein the drying stage produces slices having a degree of crispness via a textural kinetics definition.

6. The method of claim 1, wherein the drying stage produces slices having an approximate four percent moisture content or less.

7. The method of claim 1, wherein a target fat removal percentage of the slices is between 18-20% by weight after exiting the dryer stage.

8. The method of claim 1, wherein at least one second substance is added to the dried slices during the stage, the at least one second substance includes one or more preservative, one or more antioxidant, one or more anti-rancid substance, one or more seasoning including a flavoring agent or some combination thereof.

9. The method of claim 7, wherein the preservative substance is from the group consisting of one of rosemary extract, ascorbic acid, Butylated Hydroxy Toluene (BHT), Treitiary Butyl Hydo Quinone (TBHQ), polyphenol antioxidant, Chicoric acid, Chlorogenic acid, Cinnamic acid and Cinnamic acid derivatives.

10. The method of claim 1, wherein exiting the drying stage the slices are packaged in a modified atmosphere, wherein oxygen is first removed from the package and the package is filled with one of nitrogen, carbon dioxide or nitrogen blended with carbon dioxide before the slices are deposited into the package.

11. The method of claim 1, wherein the slices are arranged in a monolayer configuration in the drying stage on a conveyor having a ridged belt with a crevice located between two ridges.

12. The method of claim 11, wherein drying of the slices in the drying stage is furthered by the slices being supported by the ridges, the ridges provide partial removal of the fat from the slices as well as allow a portion of the fat to remain on the slices to allow for flavor and a desired mouth texture experience.

13. The method of claim 11, wherein the ridges of the ridged belt vary in a height approximately 5 mm to 8 mm, and the crevices are approximately 14 mm to 15 mm apart so that two to three ridges support each slice.

14. The method of claim 11, wherein the ridged belt is a pin-style joint interlocking belt, the ridges allow the slices to be dehydrated on the apex of each ridge for oil from each slice to fall into the crevice.

15. A method of making a meat-based food product comprising:
arranging a plurality of meat slices on a conveyor having a ridged belt with a crevice located between two ridges;
drying the slices in a drying stage by a microwave energy device; and
depositing the dried slices in a package under a modified atmosphere, wherein oxygen is first removed from the package and the package is filled with one of nitrogen, carbon dioxide or nitrogen blended with carbon dioxide before the slices are deposited into the package.

16. The method of claim 15 further comprising:
making a meat-based food product, comprising:
forming minced meat into a blended form;
encasing the blended form;
heating the blended form to at least approximately 145° F. to 160° F.;
chilling the blended form to at least approximately 40° F.; and
slicing the chilled blended form into a plurality of meat slices that have first and second sides spaced apart by a thickness having a range from approximately 0.039 inches to approximately 0.187 inches.

17. The method of claim 15 further comprising moving the dried slices from the dryer stage to a cooling stage, the cooling stage incorporates an ambient air medium passing through the dried slices.

18. The method of claim 15 wherein the slices are dried by an approximate 1,500 W for approximately 90 seconds to approximately 105 seconds in a dryer to produce dried slices.

19. The method of claim 15, wherein the ridges of the ridged belt vary in a height approximately 5 mm to 8 mm, a crevice is located between the ridges having a length approximately 14 mm to 30 mm apart so that two to three ridges support each slice.

20. A system of making a meat-based food product comprising:
a microwave energy device; and
a conveyor having a ridged belt with a crevice located between two ridges, the ridges are configured to support a meat based product,
wherein the conveyor belt is positioned relative to the microwave energy device to transport the meat based product through a microwave energy field generated by the microwave energy device.
